(19) United States
(12) Patent Application Publication
(10) Pub. No.: US 2018/0035858 A1
(43) Pub. Date: Feb. 8, 2018

(54) ROBOT CLEANER AND METHOD FOR CONTROLLING THE SAME

(71) Applicant: EVERYBOT INC., Seongnam-si, Gyeonggi-do (KR)

(72) Inventors: Woo Chul JUNG, Hwaseong-si, Gyeonggi-do (KR); Sang Hoon KIM, Sokcho-si, Gangwon-do (KR)

(21) Appl. No.: 15/553,521

(22) PCT Filed: Feb. 25, 2016
(86) PCT No.: PCT/KR2016/001871

§ 371 Date: Aug. 24, 2017

(30) Foreign Application Priority Data
Feb. 26, 2015 (KR) 10-2015-0027471

(51) Int. Cl. A47L 9/28; A47L 5/24; A47L 11/40

(52) U.S. Cl. CPC A47L 9/2852; A47L 11/4011; A47L 5/24; A47L 11/4063; A47L 2201/04

(57) ABSTRACT

Provided herein is a robot cleaner. The robot cleaner includes a main body, a driving unit provided in the main body and supplying power for traveling of the robot cleaner, first and second rotary members respectively rotating about first and second rotational axes based on power from the driving unit to provide a movement power source for traveling of the robot cleaner and allowing cleaners for wet cleaning to be fixed thereto, a push stick sensing unit sensing whether a push stick for manual cleaning is coupled to the main body of the robot cleaner, and a controller setting a manual cleaning mode, among cleaning modes of the robot cleaner, when coupling of the push stick is sensed.

### TECHNICAL FIELD

The present invention relates to a robot cleaner and a method for controlling the same, and more particularly, to a robot cleaner for performing wet cleaning, while autonomously traveling, and a method for controlling the same.

### BACKGROUND ART

With the development of industrial technologies, various devices have been automated. As well known, a robot cleaner is utilized as an appliance that automatically cleans an area desired to be cleaned by sucking foreign objects such as dust, or the like, or scrubbing foreign matter (or impurities) from a surface to be cleaned (or a target cleaning surface), while traveling in the area, without a user operation.

In general, a robot cleaner may include a vacuum cleaner performing cleaning with a suction force using a power source such as electricity, or the like.

A robot cleaner including such a vacuum cleaner, however, has limitations in that it cannot remove impurities or stains set in a target cleaning surface, and thus, recently, a robot cleaner having a floorcloth attached thereto to perform wet cleaning has emerged.

However, a wet cleaning scheme using a general robot cleaner is a simple scheme of attaching a floorcloth to a lower portion of the existing robot cleaner for vacuum cleaning, having a low effect of removing foreign object and not performing effective wet cleaning.

In particular, the robot cleaner based on the general wet cleaning scheme travels using a movement scheme of an existing suction type vacuum cleaner and an avoidance method regarding an obstacle as is, and thus, it cannot easily remove a foreign object set in the target cleaning surface, although it removes dust from the target cleaning surface.

Also, the general robot cleaner having the floorcloth-attached structure is moved by wheels in a state in which frictional force with the floor is high due to the plane of the floorcloth, additional driving force to move the wheels is required, increasing battery consumption.

### DISCLOSURE

### Technical Problem

An object of the present invention is to provide a robot cleaner in which a rotational force of a pair of rotary members is used as a movement power source of the robot cleaner and a cleaner for wet cleaning is fixed to a rotary member, thus performing wet cleaning, while traveling, and a method for controlling the same.

Another object of the present invention is to provide a robot cleaner allowing a user to perform manual cleaning using a push stick, as well as automatic cleaning, and a method for controlling the same.

### Technical Solution

According to an exemplary embodiment of the present invention, a robot cleaner may include: a main body; a driving unit provided in the main body and supplying power for traveling of the robot cleaner; first and second rotary members respectively rotating about first and second rotational axes based on power from the driving unit to provide movement power for traveling of the robot cleaner and allowing cleaners for wet cleaning to be fixed thereto; a push stick sensing unit sensing whether a push stick for manual cleaning is coupled to the main body of the robot cleaner; and a controller setting a manual cleaning mode, among cleaning modes of the robot cleaner, when coupling of the push stick is sensed.

When the manual cleaning mode is set, the controller may determine a cleaning direction of a user on the basis of a user's force applied to the push stick and control at least one of a rotation direction and a rotation speed of at least one of the first and second rotary members to provide movement power for assisting the user's force.

The controller may control at least one of a rotation direction and a rotation speed of at least one of the first and second rotary members such that the robot cleaner travels in a direction corresponding to the determined cleaning direction.

An opening allowing the push stick to be attached to or detached from may be provided in an upper portion of the main body, and the push stick sensing unit may sense attachment or detachment of the push stick to or from the opening, and when the push stick is attached, the push stick sensing unit may sense a user's force applied to the push stick and transmit a sensing signal to the controller.

When the user's cleaning direction is a forward direction, the controller may control the driving unit to rotate the first rotary member in a first direction and rotate the second rotary member in a second direction opposite to the first direction at the same speed as that of the first rotary member, and when the user's cleaning direction is a backward direction, the controller may control the driving unit to rotate the first rotary member in the second direction and rotate the second rotary member in the first direction at the same speed as that of the first rotary member.

When the user's cleaning direction is a lateral direction, the controller may control the driving unit such that a rotation speed of one of the first and second rotary members is different from that of the other.

The robot cleaner may further include: a bumper provided on an outer circumference of the main body to protect the main body; and an external impact sensing unit sensing an external impact applied to the bumper, wherein when the manual cleaning mode is set, the controller may perform controlling such that traveling of the robot cleaner using a sensing signal received from the external impact sensing unit is not controlled.

A default rotation speed of the first and second rotary members in the manual cleaning mode may be lower than that of the first and second rotary members in an automatic cleaning mode.

The push stick may include an input unit receiving a user input to set at least one of a tilted angle and a rotation speed of the first and second rotary members.

According to another exemplary embodiment of the present invention, a method for controlling a robot cleaner which travels in a specific movement direction by rotating at least one of first and second rotary members respectively rotating about first and second rotational axes, may include: sensing whether a push stick for manual cleaning is coupled to a main body of the robot cleaner; when coupling of the push stick is sensed, setting a cleaning mode of the robot cleaner to a manual cleaning mode; when the manual cleaning mode is set, determining a user's cleaning direction; and controlling at least one of a rotation direction and a rotation speed of at least one of the first and second rotary members to provide movement power in the determined cleaning direction.

In the determining, when the manual cleaning mode is set, a user's cleaning direction may be determined on the basis of a user's force applied to the push stick, and in the controlling, at least one of a rotation direction and a rotation speed of at least one of the first and second rotary members may be controlled to provide movement power for assisting the user's force when manual cleaning is performed in the determined cleaning direction.

In the controlling, at least one of a rotation direction and a rotation speed of at least one of the first and second rotary members may be controlled such that the robot cleaner travels in a direction corresponding to the determined cleaning direction.

An opening allowing the push stick to be attached to or detached from may be provided in an upper portion of the main body, and in the sensing, attachment or detachment of the push stick to or from the opening may be sensed, and when the push stick is attached, a user's force applied to the push stick may be sensed and a sensing signal may be transmitted to a controller.

In the controlling, when the user's cleaning direction is a forward direction, a driving unit may be controlled to rotate the first rotary member in a first direction and rotate the second rotary member in a second direction opposite to the first direction at the same speed as that of the first rotary member, and when the user's cleaning direction is a backward direction, the driving unit may be controlled to rotate the first rotary member in the second direction and rotate the second rotary member in the first direction at the same speed as that of the first rotary member.

In the controlling, when the user's cleaning direction is a lateral direction, the driving unit may be controlled such that a rotation speed of one of the first and second rotary members is different from that of the other.

The method may further include: sensing an external impact applied to a bumper provided on an outer side of a main body of the robot cleaner; and when the manual cleaning mode is set, performing controlling such that traveling of the robot cleaner using a sensing signal corresponding to the external impact is not controlled.

A default rotation speed of the first and second rotary members in the manual cleaning mode may be lower than that of the first and second rotary members in an automatic cleaning mode.

The method may further include: receiving a user input to set at least one of a tilted angle and a rotation speed of the first and second rotary members in the push stick.

### Advantageous Effects

According to the various exemplary embodiments of the present invention described above, the robot cleaner may travel, while performing wet cleaning, using rotational force of the pair of rotary member as a movement power source.

Also, according to the various exemplary embodiments of the present invention described above, since the robot cleaner uses rotational force of the pair of rotary members as a movement power source, battery efficiency may be improved.

In addition, according to the various exemplary embodiments of the present invention described above, the robot cleaner may effectively remove impurities set in a target cleaning surface through frictional contact between a first cleaner and a second cleaner respectively rotating according to rotational motions of a first rotary member and a second rotary member and a target cleaning surface.

In addition, according to the various exemplary embodiments of the present invention described above, the robot cleaner may provide the manual cleaning mode in which the push stick is coupled to the robot cleaner and the robot cleaner performs cleaning, while traveling on the basis of a user's force applied to the push stick, as well as the automatic cleaning mode in which the robot cleaner performs cleaning, while automatically traveling. In particular, when the manual cleaning mode is set, the robot cleaner may provide movement power for assisting a user's force in a direction corresponding to a manual cleaning direction of the user, and accordingly, the user may perform cleaning by applying a less force.

### DESCRIPTION OF DRAWINGS

FIG. 1 is an exploded perspective view of a robot cleaner according to various exemplary embodiments of the present invention.

FIG. 2 is a bottom view of a robot cleaner according to various exemplary embodiments of the present invention.

FIG. 3 is a front view of a robot cleaner according to various exemplary embodiments of the present invention.

FIG. 4 is a cross-sectional view of a robot cleaner according to various exemplary embodiments of the present invention.

FIG. 5 is a block diagram of a robot cleaner according to various exemplary embodiments of the present invention.

FIGS. 6 and 7 are views illustrating a traveling operation of a robot cleaner according to various exemplary embodiments of the present invention.

FIG. 8 is a view illustrating a robot cleaner and a push stick according to various exemplary embodiments of the present invention.

FIGS. 9A and 9B are views illustrating an operation of a robot cleaner when a user's manual cleaning direction is a forward direction or a backward direction.

FIGS. 10A and 10B are views illustrating an operation of a robot cleaner when a user's manual cleaning direction is a left forward direction or a right forward direction.

FIG. 11 is a block diagram illustrating an input unit of a push stick according to various exemplary embodiments of the present invention.

FIGS. 12A to 12D are views illustrating a user's force applied to a push stick according to various exemplary embodiments of the present invention.

FIG. 13 is a flow chart illustrating a method for controlling a robot cleaner according to various exemplary embodiments of the present invention.

### BEST MODE

The following content merely illustrates the principles of the invention. Therefore, although it is not clearly described or illustrated herein, those skilled in the art may implement the principles of the present invention that includes a wide variety of devices that can be invented. In addition, all conditional terms listed herein and understood that the embodiments are intended only for the purpose of, in principle, to understand the concept of the present invention is clearly not limited to the embodiment and state specifically enumerated.

In addition, it should be understood that all the detailed descriptions for specific embodiments, as well as the principle, perspectives, and embodiments, intentionally include structural and functional equivalents of such matters. Also, it should be understood that the equivalents include all the devices invented to perform the same functions irrespective of the equivalents, i.e., structures, to be developed in the future, as well as currently known equivalents.

Thus, for example, a block diagram of the present disclosure is to be understood to represent a conceptual point of view of an exemplary circuit that embodies the principles of the present invention. Similarly, flow diagrams, state transition, such as a pseudo-code, or the like, may be understood to be substantially represented in a computer-readable medium and represent various processes performed by a computer or a processor, no matter whether the computer or the processor is clearly illustrated.

The processor or a similar concept that includes the functional blocks shown in the drawings and various features of the device with the ability to run the software in conjunction with the appropriate software may be provided by the use of hardware, as well as dedicated hardware. Features, a single dedicated processor, by the processor when they become available, can be provided by a single shared processor, or a plurality of individual processors, some of which can be shared.

In addition, the use of control processor, or similar terms that are presented as a concept is not to be construed as exclusive of hardware, with the ability to run the software, and it should be understood as implicitly including a read-only memory (ROM), a random access memory (RAM), and a nonvolatile memory for storing the digital signal processor (DSP), hardware, and software, without limitation. Also, other well-known hardware may be included.

Components are expressed as the means to perform the functions described in the detailed description of the claims herein, including all types of software, for example, which includes a combination of circuit elements that perform the functions or the firmware/microcode intended to include, and how to perform the function of, for performing the functions mentioned above are combined with appropriate circuitry for executing software. The present invention is defined by the scope of these claims, because a combination of the features offered by various means listed and combined with the claim needs to be understood by any means that can provide the functions herein.

The aforementioned objects, features and advantages will become more apparent through the following detailed description with respect to the accompanying drawings, the technical idea of the present invention with a person of ordinary skill in the art the present invention, accordingly, can be easily carried out. In describing the present invention, a detailed description of known techniques associated with the present invention unnecessarily obscure the gist of the present invention, it is determined that the detailed description thereof will be omitted.

Hereinafter, various exemplary embodiments of the present invention will be described in detail with reference to the accompanying drawings.

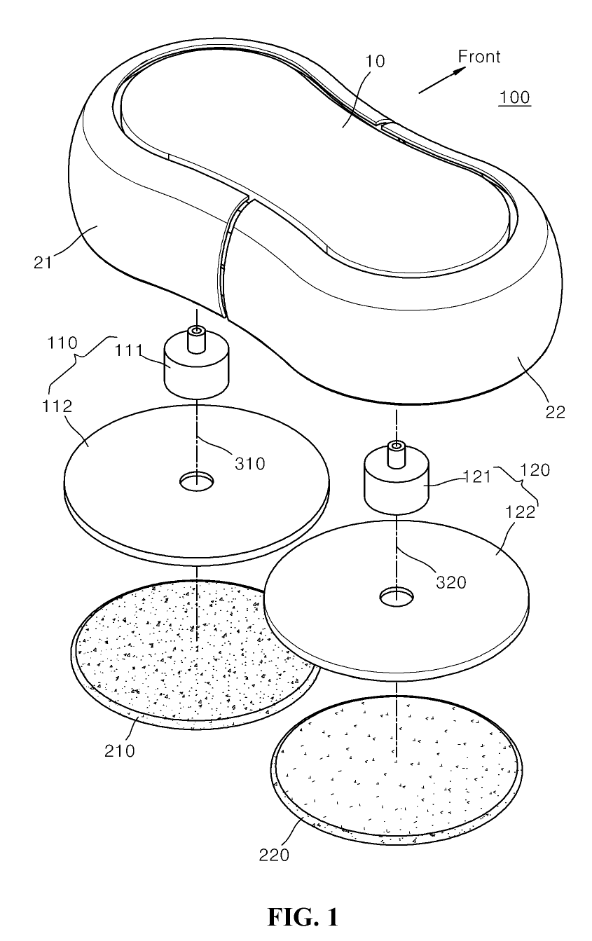

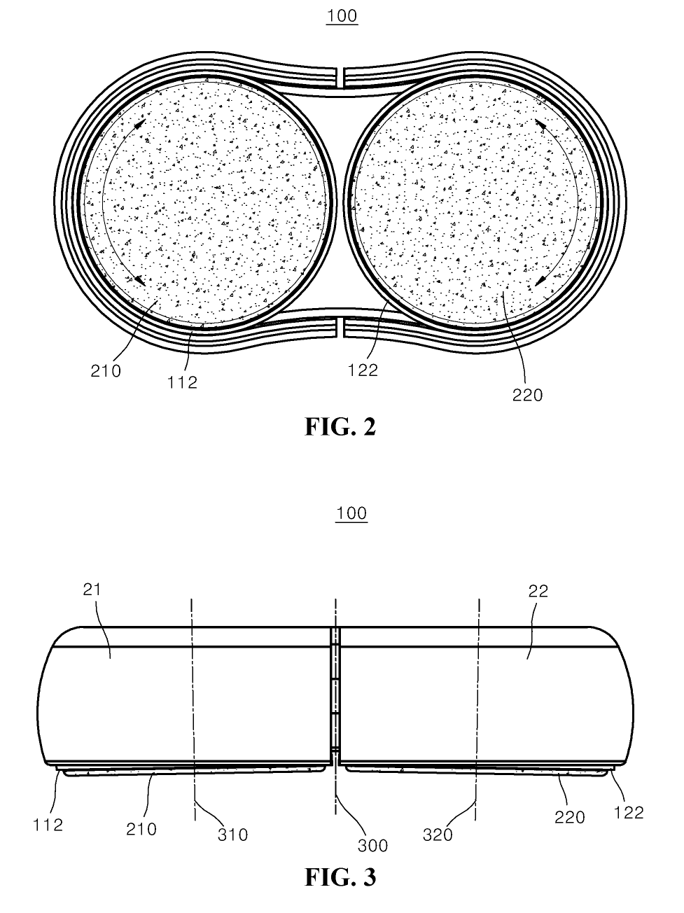

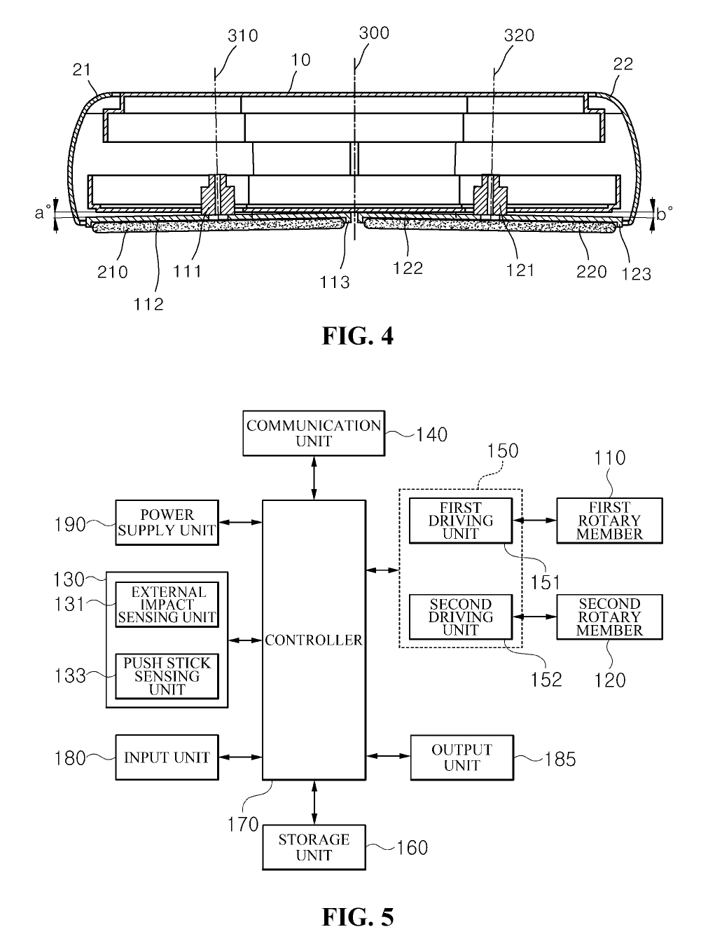

FIGS. 1 to 4 are views illustrating a structure of a robot cleaner according to an exemplary embodiment of the present invention. Specifically, FIG. 1 is an exploded perspective view of a robot cleaner according to various exemplary embodiments of the present invention, FIG. 2 is a bottom view of a robot cleaner according to various exemplary embodiments of the present invention, FIG. 3 is a front view of a robot cleaner according to various exemplary embodiments of the present invention, and FIG. 4 is a cross-sectional view of a robot cleaner corresponding to the front view of FIG. 3.

Referring to FIGS. 1 to 4, a robot cleaner 100 according to an exemplary embodiment of the present invention may include a main body 10 structurally forming an appearance of the robot cleaner 100, a bumper 20 formed on an outer circumference of the main body 10 to protect the main body 10 from an external impact, a sensing unit 130 sensing an external impact applied to the bumper 20, a driving unit 150 installed in the main body 10 to provide power enabling the robot to travel, first and second rotary members 110 and 120 coupled to the driving unit 150 to rotate, and a power supply unit 190 installed within the main body 10.

The robot cleaner 100 may travel, while performing wet cleaning using cleaners 210 and 220 for wet cleaning. Here, wet cleaning may refer to scrubbing a surface to be cleaned (or a target cleaning surface) using the cleaners 210 and 220. For example, wet cleaning may include both cleaning using a dry floorcloth and cleaning using a floorcloth wet with a liquid.

The driving unit 150 may include a first driving unit 151 installed within the main body 10 and coupled to the first rotary member 110 and a second driving unit 152 installed within the main body 10 and coupled to the second rotary member 120. Here, the driving unit 150 may be implemented by including a motor, a gear assembly, and the like.

The first rotary member 110 may include a first transmission member 111 coupled to the first driving unit 151 to transmit power based on the first driving unit 151, and rotating about a first rotational axis 310 based on the power. Also, the first rotary member 110 may include a first fixing member 112 to which the first cleaner 210 for wet cleaning may be fixed.

The second rotary member 120 may include a second transmission member 121 coupled to the second driving unit 152 to transmit power based on the second driving unit 152 and rotating about a second rotational axis 320 based on the power. Also, the second rotary member 120 may include a second fixing member 122 to which the second cleaner 220 for wet cleaning may be fixed.

Here, when the first transmission member 111 and the second transmission member 121 are coupled to the main body 10, lower end regions of the first transmission member 111 and the second transmission member 121 may be protrude in a direction toward a target cleaning surface. Or, when the first transmission member 111 and the second transmission member 121 are coupled to the main body 10, the first transmission member 111 and the second transmission member 121 may not protruded in the direction toward the target cleaning surface.

Also, when the first fixing member 112 and the second fixing member 122 are coupled to the main body 10, the first fixing member 112 and the second fixing member 122 may protrude in a direction toward the target cleaning surface, e.g., a floor, and the first cleaner 210 and the second cleaner 220 may be fixed thereto, respectively.

The first cleaner 210 and the second cleaner 220 may be formed of a fiber material such as a floorcloth used to scrub various target cleaning surfaces, such as a microfibrous cloth, a cloth, felt, a brush, and the like, to remove foreign matter set in a floor through a rotational motion. Also, the first cleaner 210 and the second cleaner 220 may have a circular shape as illustrated in FIG. 1, but without being limited thereto, the first cleaner 210 and the second cleaner 220 may be implemented to have various shapes.

The first and second cleaners 210 and 220 may be put on the first and second fixing members 112 and 122 so as to be fixed to the first and second fixing members 112 and 122, or may be fixed to the first and second fixing members 112 and 122 using a separate adhering unit. For example, the first and second cleaners 210 and 220 may be adhered and fixed to the first and second fixing members 112 and 122 by the Velcro tap, or the like, respectively.

The robot cleaner 100 according to an exemplary embodiment of the present invention may remove foreign matter set in the floor through frictional contact with the target cleaning surface as the first and second cleaners 210 and 220 rotate according to rotational motions of the first and second rotary members 110 and 120. Also, when frictional force is generated with respect to the target cleaning surface, the frictional force may be used as a movement power source of the robot cleaner 100.

In detail, in the robot cleaner 100 according to an exemplary embodiment of the present invention, frictional force with respect to the target cleaning surface is generated according to rotation of the first and second rotary members 110 and 120, and a movement speed and a direction of the robot cleaner 100 may be adjusted according to a magnitude of a resultant force and a direction in which the resultant force acts.

In particular, referring to FIGS. 3 and 4, the first and second rotational axes 310 and 320 of the first and second rotary members 110 and 120 based on power of the pair of driving units 151 and 152 may be tilted at a predetermined angle with respect to a central axis 300 corresponding to an axis in a vertical direction of the robot cleaner 100. Here, the first and second rotary members 110 and 120 may be tilted to the outside downwards with respect to the central axis 300. That is, among regions of the first and second rotary members 110 and 120, a region away from the central axis 300 may be more strongly adhered to the target cleaning surface than a region closer to the central axis 300.

Here, the central axis 300 may refer to a longitudinal axis with respect to the target cleaning surface of the robot cleaner 100. For example, when it is assumed that the robot cleaner 100 travels on an X-Y plane formed by X and Y axes to perform cleaning during a cleaning operation, the central axis 300 may refer to a Z axis of the robot cleaner 100, perpendicular to the target cleaning surface.

Meanwhile, the predetermined angle may include a first angle (angle a) corresponding to an angle at which the first rotational axis 310 is tilted with respect to the central axis 300 and a second angle (angle b) corresponding to an angle at which the second rotational axis 320 is tilted with respect to the central axis 300. Here, the first angle and the second angle may be the same or different.

The first and second angles may each preferably be within a range from 1° to 3°. Here, the aforementioned angle range may be a range in which wet cleaning capability, traveling speed, and traveling performance of the robot cleaner 100 is optimally maintained as can be seen in Table 1 below.

TABLE 1

| | Cleaning capability | Traveling speed |
|---|---|---|
| Tilted angle | (based on 3 points) | (based on 3 points) |
| Less than 1° | Entire target cleaning | Very slow (0) |
| | surfaces in frictional | |
| | contact with cleaner can be | |
| | cleaned (3) | |
| 1° | Entire target cleaning | Slow (1) |
| | surfaces in frictional | |
| | contact with cleaner can be | |
| | cleaned (3) | |
| 1.85° | Target cleaning surfaces in | Normal (2) |
| | frictional contact with | |
| | cleaner, excluding a portion | |
| | near central axis, can be | |
| | cleaned (2) | |
| 3° | Target cleaning surfaces in | Fast (3) |
| | frictional contact with | |
| | cleaner, excluding a portion | |
| | near central axis, can be | |
| | cleaned (1) | |
| Greater than 3° | Target cleaning surfaces in | Fast (3) |
| | frictional contact with | |
| | cleaner, excluding most | |
| | regions near central axis, | |
| | can be cleaned (0) | |

Referring to Table 1 above, since the robot cleaner 100 has a structure in which the pair of rotational axes 310 and 320 are tilted at a predetermined angle with respect to the central axis 300, a traveling speed and cleaning capability of the robot cleaner 100 may be adjusted. In particular, wet cleaning capability and a traveling speed of the robot cleaner 100 may be optimally maintained by maintaining the predetermined angle at a range from 1° to 3°. However, various exemplary embodiments of the present invention may not be limited thereto.

Meanwhile, when the pair of rotary members 110 and 120 rotate according to the predetermined angle, a relative frictional force generated between the pair of rotary members 110 and 120 and the target cleaning surface may be greater in an outer portion of the main body 10 than in a central portion thereof. Thus, a movement speed and direction of the robot cleaner 100 may be controlled by the relative frictional force generated by controlling each of the pair of rotary members 110 and 120. Controlling the movement speed and direction of the robot cleaner 100 according to an exemplary embodiment of the present invention will be described hereinafter.

Meanwhile, when the robot cleaner 100 travels according to the aforementioned operations, the robot cleaner 100 may collide with various obstacles present on the target cleaning surface. Here, the obstacles may include various obstacles hindering traveling of the robot cleaner 100 for performing cleaning, such as a low obstacle like a threshold, carpet, and the like, an obstacle positioned to float at a predetermined height like a sofa, a bed, and the like, and a high obstacle like a wall, or the like.

Here, the bumper 20 formed on an outer circumference of the main body 10 of the robot cleaner 100 may protect the main body 10 from an external impact due to collision with an obstacle and absorb the external impact. Also, the sensing unit 130 installed within the main body 10 may sense the impact applied to the bumper 10.

The bumper 20 may include a first bumper 21 formed on a first outer circumference of the main body 10 and a second bumper 22 formed on a second outer circumference of the main body 10, separate from the first bumper 21. Here, the bumper 20 may be formed on left and right circumferences of the main body 10 with respect to a direction F in which a front side of the robot cleaner 100 faces. For example, referring to FIGS. 1 to 4, the first bumper 21 may be formed on the left circumference of the main body 10 with respect to the direction F in which the front side of the robot cleaner 100 faces, and the second bumper 22 may be formed on the right circumference of the main body 10 with respect to the direction F in which the front side of the robot cleaner 100 faces.

Here, the first bumper 21 and the second bumper 22 may be implemented as physically separate different bumpers. Thus, the bumpers 21 and 22 of the robot cleaner 100 may separately operate. That is, in cases where the first bumper 21 collides with an obstacle while the robot cleaner 100 is traveling, the first bumper 21 absorbs an external impact and transmits the absorbed external impact to a first sensing unit installed to correspond to the first bumper 21. However, since the second bumper 22 is implemented as a bumper physically separate from the first bumper 21, the second bumper 22 is not affected by the collision and a second sensing unit installed to correspond to the second bumper 22 may not receive the external impact.

Meanwhile, according to an exemplary embodiment of the present disclosure, upper and lower ends of the bumper 20 are formed at a height to correspond to predetermined conditions, whereby the robot cleaner 100 may sense various obstacles that the robot cleaner 100 encounters during traveling. This will be described in detail with reference to FIG. 4.

Referring to FIG. 4, lower ends of the first bumper 21 and the second bumper 22 may be formed to be as close as possible to the target cleaning surface. In detail, a distance between the lower ends of the first bumper 21 and the second bumper 22 and the target cleaning surface may be equal to or smaller than a thickness of the cleaners 210 and 220. Thus, the first and second bumpers 21 and 22 may collide with a low obstacle such as a thin threshold, carpet, and the like, to sense and avoid the low obstacle.

Also, upper ends of the first and second bumpers 21 and 22 may be formed to prevent occurrence of a phenomenon in which only an obstacle is caught by only the main body 10, without colliding with the bumpers 21 and 22. In detail, heights of the upper ends of the first and second bumpers 21 and 22 may be equal to or higher than a height of the main body 10. Thus, the first and second bumpers 21 and 22 may collide with an obstacle positioned to float at a predetermined height, such as a sofa, a bed, and the like, preventing occurrence of a phenomenon in which the obstacle is caught by only the main body 10, without colliding with the first and second bumpers 21 and 22.

Meanwhile, according to an exemplary embodiment of the present invention, the robot cleaner 100 may have guide parts 113 and 123 guiding the cleaners 210 and 220 to be fixed to optimal positions, respectively.

If the cleaners 210 and 220 are not fixed to optimal positions, the first and second cleaners 210 and 220 may come into contact with different target cleaning surfaces according to rotation of the first and second rotary members 112 and 122, forming an unbalanced state therebetween. Here, the robot cleaner 100 may not perform desired traveling. For example, the robot cleaner 100 in a straight traveling mode may travel to form a curved line, rather than performing straight traveling.

Thus, according to an exemplary embodiment of the present invention, lower surfaces of the first and second rotary members 112 and 122 to which the cleaners 210 and 220 are respectively fixed may have the guide parts 113 and 123 protruding toward the target cleaning surface from edges of the lower surfaces to allow the cleaners 210 and 220 to be fixed in optimal positions. Accordingly, a user of the robot cleaner 100 may fix the cleaners 210 and 220 to optimal positions.

Meanwhile, the sensing unit 130 may sense an external impact applied to the bumper 20. Here, the sensing unit 130 may include a plurality of sensing units installed in positions respectively corresponding to the plurality of bumpers. For example, when two bumpers 21 and 22 are implemented, the sensing unit 130 may include at least one first sensing unit installed to correspond to the first bumper 21 and at least one second sensing unit installed to correspond to the second bumper 22, and may be implemented as a contact sensor, an optical sensor, and the like. The sensing unit 130 may transmit a sensing result to a controller 170.

Also, the controller 170 may determine a collision position of a portion of the bumper 20 which has collided with the obstacle using the sensing result from the sensing unit 130, and control the first and second driving units 151 and 152 to avoid the obstacle on the basis of the determined collision position.

FIG. 5 is a block diagram of a robot cleaner according to an exemplary embodiment of the present invention. Referring to FIG. 5, the robot cleaner according to an exemplary embodiment of the present invention includes a sensing unit 130, a communication unit 140, a driving unit 150 for driving first and second rotary members 110 and 120, a storage unit 160, a controller 170, an input unit 180, an output unit 185, and a power supply unit 190.

The sensing unit 130 may sense various types of information required for an operation of the robot cleaner 100 and transmit a sensing signal to the controller 170. Here, the sensing unit 130 may include both or only any one of an external impact sensing unit 131 and a push stick sensing unit 133.

The external impact sensing unit 131 may sense an external impact applied to the bumper 20 and transmit a sensing signal to the controller 170. The external impact sensing unit 131 may be implemented as a contact sensor, an optical sensor, and the like.

The push stick sensing unit 133 may sense detachment or attachment of a push stick 500 for manual cleaning to or from the main body 10 of the robot cleaner 100, and when the push stick 500 for manual cleaning is attached to the main body 10 of the robot cleaner 100, the push stick sensing unit 133 may sense a user's force applied to the push stick 500 and transmit a sensing signal to the controller 170. Here, the push stick 500 may be implemented as a stick for transmitting a user's force to the robot cleaner 100. The user's force applied to the push stick 500 may include a force applied to cause the robot cleaner 100 to move forwards, a force applied to pull the robot cleaner 100 to cause the robot cleaner 100 to move backwards, and the like.

The communication unit 140 may include one or more modules enabling wireless communication between the robot cleaner 100 and another wireless terminal or between the robot cleaner 100 and a network in which another wireless terminal is positioned. For example, the communication unit 140 may communicate with a wireless terminal as a remote controller, for which the communication unit 140 may include a short-range communication module, a wireless Internet module, and the like.

The robot cleaner 100 may be controlled in an operational state, an operation method, and the like, by a control signal received by the communication unit 140. A terminal controlling the robot cleaner 100 may include, for example, a smartphone, a tablet PC, a personal computer, a remote controller, and the like, available for performing communication with the robot cleaner 100.

The driving unit 150 may supply power for rotating the first and second rotary members 110 and 120 under the control of the controller 170. Here, the driving unit 150 may include a first driving unit 151 and a second driving unit 152, and may be implemented by including a motor and/or a gear assembly.

Meanwhile, the storage unit 160 may store a program for an operation of the controller 170 and may temporarily store input/output data. The storage unit 160 may include at least one type of storage medium among a flash memory type, a hard disk type, a multimedia card micro-type, a card type memory (e.g., an SD or XD memory, etc.) a random access memory (RAM), a static RAM (SRAM), a read-only memory (ROM), a programmable ROM (PROM), an electrically erasable programmable ROM (EEPROM), a magnetic memory, a magnetic disk, and an optical disk.

The input unit 180 may receive a user input operating the robot cleaner 100. In particular, the input unit 180 may receive a user input selecting an operation m ode of the robot cleaner 100.

Here, the input unit 180 may be configured as a key pad, a dome switch, a touch pad (static pressure/capacitance), a jog wheel, a jog switch, and the like.

The output unit 185 serves to generate an output related to a sense of sight, a sense of hearing, and the like. Although not shown, the output unit 185 may include a display unit, an audio output module, an alarm unit, and the like.

The display unit displays (outputs) information processed in the robot cleaner 100. For example, when the robot cleaner is performing cleaning, the display unit may display a user interface (UI) or a graphic user interface (GUI) displaying a cleaning time, a cleaning method, a cleaning region, and the like, related to a cleaning mode.

The power supply unit 190 supplies power to the robot cleaner 100. In detail, the power supply unit 190 may supply power to each functional unit forming the robot cleaner 100, and when remaining power capacity is insufficient, the power supply unit 190 may be charged upon receiving a charge current. Here, the power supply unit 190 may be implemented as a rechargeable battery.

The controller 170 generally controls a general operation of the robot cleaner 100. In detail, the controller 170 may control the driving unit 150 to rotate at least one of the first rotary member 110 and the second rotary member 120 to cause the robot cleaner 100 to travel in a specific moving direction.

For example, when the first and second rotary members 110 and 120 rotate at the same speed in the same direction, the robot cleaner 100 may rotate on the spot. The robot cleaner 100 may rotate on the spot according to a speed at which the first and second rotary members 110 and 120 rotate.

In detail, when the first and second rotary members 110 and 120 rotate at the same speed in the same direction, one end and the other end positioned opposite to each other with respect to the center of the main body 10 of the robot cleaner 100 move in mutually opposite directions with respect to the target cleaning surface. That is, a direction in which one end positioned on the opposite side of the first rotary member 110 of the robot cleaner 100 moves on the target cleaning surface according to rotation of the first rotary member 110 and a direction in which the other end positioned on the opposite side of the second rotary member 120 of the robot cleaner 100 moves on the target cleaning surface according to rotation of the second rotary member 120 are opposite to each other.

Accordingly, resultant forces of frictional forces may act on the robot cleaner 100 in mutually opposite directions, acting as a rotational force of the robot cleaner 100.

In another example, the controller 170 may control the first and second rotary members 110 and 120 to rotate at the same speed in mutually different directions. Here, a direction in which one end moves on target cleaning surface by a frictional force of the first rotary member 110 with respect to the main body 10 of the robot cleaner 100 may be the same as a direction in which the other end moves on the target cleaning surface by a frictional force of the second rotary member 120.

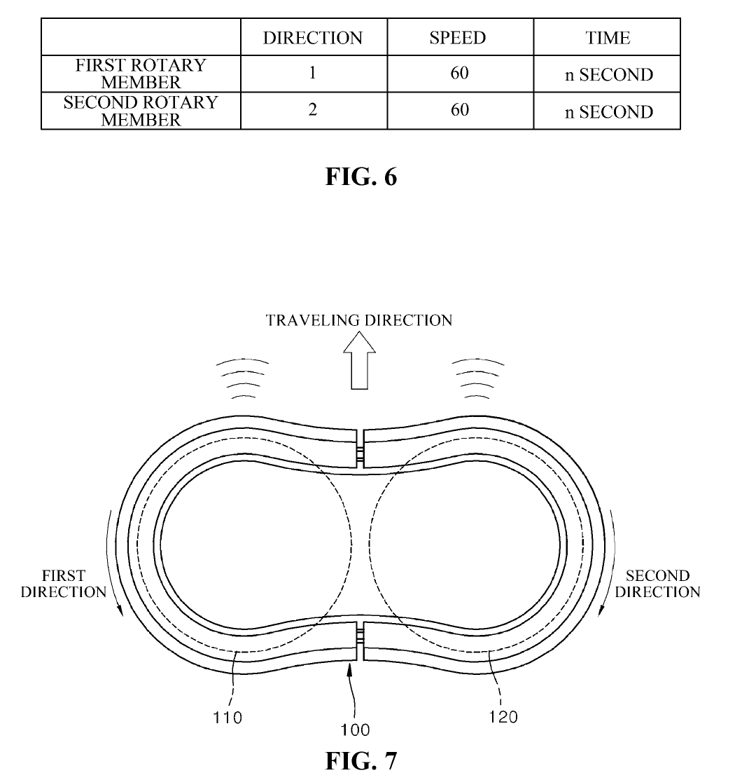

Accordingly, the robot cleaner 100 may perform straight traveling in a specific direction. This will be described in detail with reference to FIGS. 6 and 7 hereinafter.

FIGS. 6 and 7 are views illustrating a traveling operation of a robot cleaner according to an exemplary embodiment of the present invention.

FIG. 6 illustrates a rotation control table for implementing straight traveling of a robot cleaner according to an exemplary embodiment of the present invention. The controller 170 may control rotation of each of the rotary members 110 and 120 by controlling the driving unit 150 on the basis of the rotation control table values stored in the storage unit 160. The rotation control table may include at least one of a direction value, a speed value, and a time value allocated to each of the rotary members 110 and 120 in each movement mode. As illustrated in FIG. 6, a rotation direction of the first rotary member 110 and a rotation direction of the second rotary member 120 may be different. Also, rotation speeds and time of the first and second rotation members 110 and 120 may be the same.

A rotation direction of the rotary members according to an exemplary embodiment of the present invention may be described on the basis of a direction in which the robot cleaner 100 is viewed from above. For example, a first direction may refer to a direction in which the robot cleaner 100 is rotated in a counterclockwise direction on the basis of a moving direction 300 as 12 o'clock in a state in which the robot cleaner 100 is viewed from above. Also, a second direction, different from the first direction, may refer to a direction in which the robot cleaner 100 is rotated in a clockwise direction on the basis of the moving direction 300 as 12 o'clock.

Here, the robot cleaner 100 may perform straight traveling as illustrated in FIG. 7. Referring to FIG. 7, the robot cleaner 100 according to an exemplary embodiment of the present invention may generate a relative movement power based on a frictional force and perform straight traveling in a traveling direction by rotating the first rotary member 110 in the first direction and rotating the second rotary member 120 in the second direction different to the first direction.

Meanwhile, a direction in which the rotational axes 310 and 320 are tilted in FIGS. 1 to 7 described above is merely illustrative and may be implemented to be tilted in any other direction according to an implementation example. For example, the first and second rotational axes 310 and 320 of the first and second rotary members 110 and 120, respectively, may be tilted at an angle opposite to the case of FIGS. 3 and 4, with respect to the central axis 300 corresponding to a longitudinal axis of the robot cleaner 100. Here, the first and second rotary members 110 and 120 may be upwardly tilted to an outer side with respect to the central axis 300. That is, among regions of the first and second rotary members 110 and 120, a region positioned to be closer to the central axis 300 may be more strongly adhered to the target cleaning surface than a region positioned to be away from the central axis 300. Here, when the pair of rotary members 110 and 120 rotate, a relative frictional force generated between the rotary members 110 and 120 and the target cleaning surface may be large at the center of the main body 10 than at an outer side thereof.

Thus, opposite to the case of FIGS. 1 to 7, a movement speed and a direction of the robot cleaner 100 may be controlled by controlling rotation of each of the pair of rotary members 110 and 120. In detail, the robot cleaner 100 may generate relative movement power based on a frictional force and perform straight traveling in a moving direction by rotating the first rotary member 110 in the second direction and rotating the second rotary member 120 in the first direction different to the second direction.

Meanwhile, the robot cleaner 100 according to an exemplary embodiment of the present invention may provide a plurality of cleaning modes, and the plurality of cleaning modes may include an automatic cleaning mode and a manual cleaning mode.

The automatic cleaning mode may be a mode in which the robot cleaner 100 performs cleaning, while automatically traveling using a frictional force of the cleaners 310 and 320 with respect to a target cleaning surface according to rotation of the first and second rotary members 110 and 120, as a movement power source.

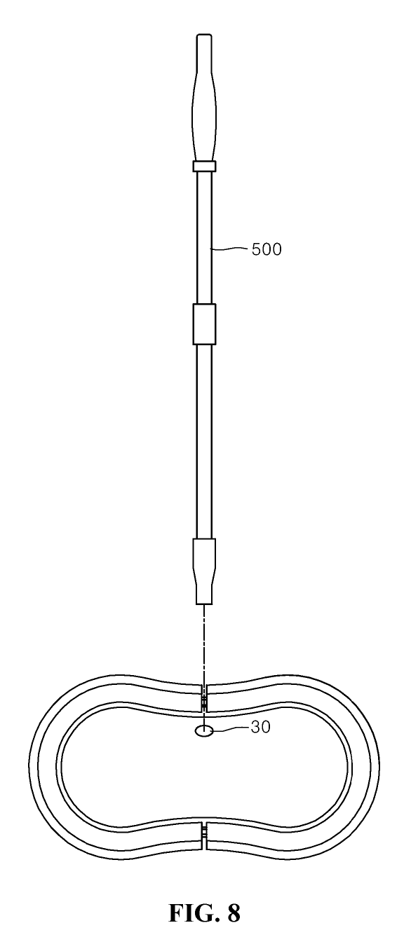

Also, the manual cleaning module may be a mode in which the robot cleaner 100 performs cleaning, while moving using a user's force applied to the push stick 500. Here, the robot cleaner 100 in the manual cleaning module may perform cleaning, while moving using a frictional force of the cleaners 310 and 320 with respect to the target cleaning surface, as auxiliary movement power, as well as the user's force applied to the push stick 500. Such a manual cleaning mode will be described in detail with reference to FIGS. 8 to 12 hereinafter.

The cleaning mode may be selected in various manners. For example, when a user input selecting a cleaning mode is received through the input unit 180, the controller 170 may set a cleaning mode of the robot cleaner 100 to a user selected cleaning mode. In another example, when attachment of the push stick 500 to the robot cleaner 100 is sensed through the push stick sensing unit 133, the controller 170 may set an operation mode of the robot cleaner 100 to a manual cleaning mode.

FIG. 8 is a view illustrating a robot cleaner and a push stick according to an exemplary embodiment of the present invention. Referring to FIG. 8, an opening 30 allowing the push stick 500 to be detached or attached may be provided in an upper portion of the main body 10 of the robot cleaner 100, and the push stick sensing unit 133 may be installed in a predetermined position of the opening 30. Accordingly, when the push stick 500 is detached from or attached to the opening 30 of the robot cleaner 100, the push stick sensing unit 133 may transmit a detachment sensing signal or an attachment sensing signal to the controller 170. Here, the push stick 500 may have an accommodation part for keeping a remote controller of the robot cleaner 100.

When a push stick 500 attachment signal is received from the push stick sensing unit 133, the controller 170 may set a cleaning mode of the robot cleaner 100 to a manual cleaning mode.

When the manual cleaning mode is set, the controller 170 may determine a manual cleaning direction of the user on the basis of a user's force applied to the push stick 500. In detail, the push stick sensing unit 133 may sense a user's force applied to the push stick 500 and transmit a sensing signal to the controller 170, and the controller 170 may determine a user's manual cleaning direction using the sensing signal received from the push stick sensing unit 133.

For example, when a user's force applied to the push stick 500 for wet cleaning of a front side of the robot cleaner 100 is sensed by the push stick sensing unit 133, the controller 170 may determine a user's manual cleaning direction as a forward direction.

In another example, when a user's force applied to the push stick 500 for wet cleaning of a rear side of the robot cleaner 100 is sensed by the push stick sensing unit 133, the controller 170 may determine a user's manual cleaning direction as a backward direction.

In another example, when a force applied to laterally push or pull the push stick 500 for wet cleaning in a lateral direction of the robot cleaner 100 is sensed by the push stick sensing unit 133, the controller 170 may determine a user's manual cleaning direction as a left-forward direction, a right-forward direction, a left-backward direction, and a right-backward direction.

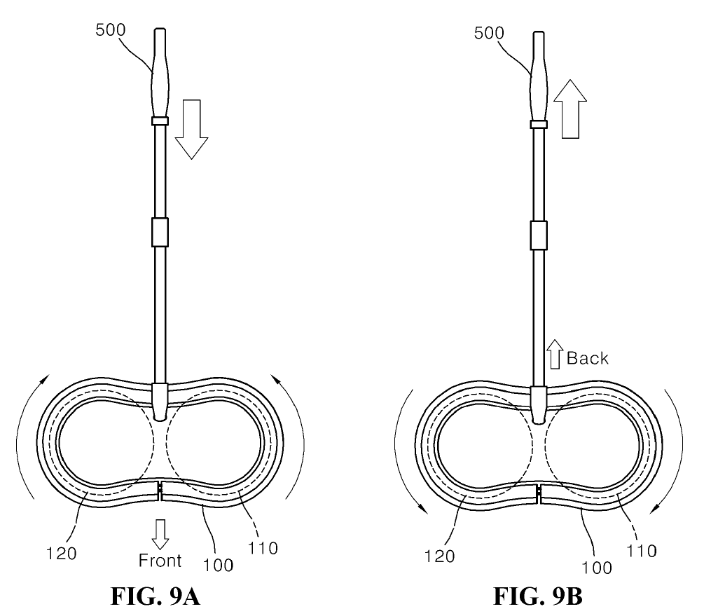

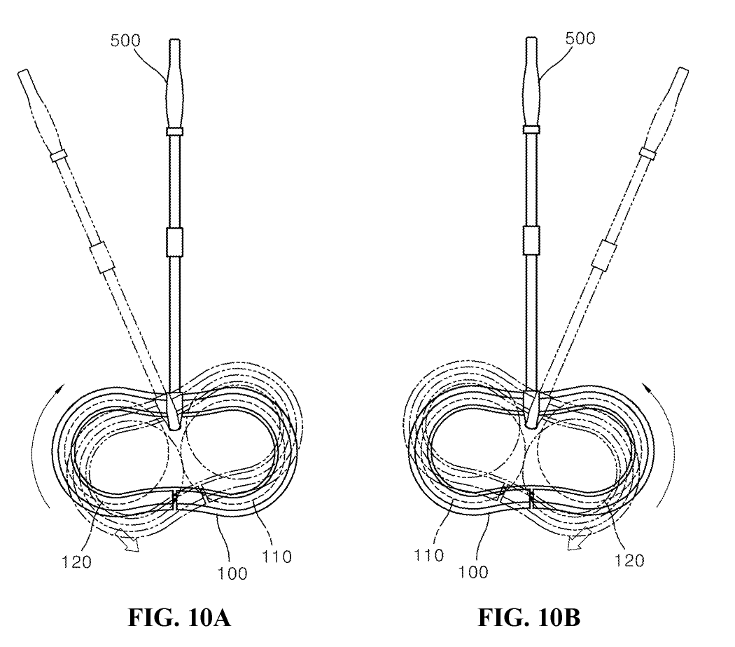

Meanwhile, when the user's manual cleaning direction is determined, the controller 170 may control at least one of a rotation direction and a rotation speed of at least one of the first and second rotary members 110 and 120 to provide movement power to assist user's force when the user performs manual cleaning. In detail, the controller 170 may control at least one of a rotation direction and a rotation speed of at least one of the first and second rotary members 110 and 120 such that the robot cleaner 100 travels in a direction corresponding to the determined manual cleaning direction. This will be described in detail with reference to FIGS. 9 and 10 hereinafter.

FIGS. 9A and 9B are views illustrating an operation of a robot cleaner when a user's manual cleaning direction is a forward direction or a backward direction.

When a user's manual cleaning direction is a forward direction of the robot cleaner 100 as illustrated in FIG. 9A, the controller 170 may control the driving unit 150 to rotate the first rotary member 110 in a counterclockwise direction and rotate the second rotary member 120 in a clockwise direction at the same speed as that of the first rotary member 110. Here, the robot cleaner 100 may generate movement power for traveling forwards by itself

Such movement power of the robot cleaner 100 for traveling forwards may be used as a force for assisting user's forward manual cleaning, and accordingly, the user may apply a less pushing force to the push stick 500 to move the robot cleaner 100 forwards to perform cleaning on a front side.

When a user's manual cleaning direction is a backward direction of the robot cleaner 100 as illustrated in FIG. 9B, the controller 170 may control the driving unit 150 to rotate the first rotary member 110 in the clockwise direction and rotate the second rotary member 120 in the counterclockwise direction at the same speed as that of the first rotary member 110. Here, the robot cleaner 100 may generate movement power for traveling backwards by itself

Such movement power of the robot cleaner 100 for traveling backwards may be used as a force for assisting user's backward manual cleaning, and accordingly, the user may apply a less pulling force to the push stick 500 to move the robot cleaner 100 backwards to perform cleaning on a rear side.

FIGS. 10A and 10B are views illustrating an operation of a robot cleaner when a user's manual cleaning direction is a left forward direction or a right forward direction. Referring to FIG. 10A and FIG. 10B, when a user's manual cleaning direction is a left forward direction or a right forward direction, the controller 170 may control the driving unit 150 such that a rotation speed of one of the first and second rotary members 110 and 120 is different to that of the other.

When a user's manual cleaning direction is a left-forward direction of the robot cleaner 100 as illustrated in FIG. 10A, the controller 170 may control the driving unit 150 not to rotate the first rotary member 110 or rotate in a counterclockwise/clockwise direction at a low speed and rotate the second rotary member 120 in a clockwise direction at a high speed. Here, the robot cleaner 100 may generate movement power for traveling left-forwards by itself

Such movement power of the robot cleaner 100 for traveling left-forwards may be used as a force for assisting user's manual cleaning, and accordingly, the user may apply a less left pushing force to the push stick 500 to move the robot cleaner 100 left-forwards to perform cleaning.

When a user's manual cleaning direction is a right-forward direction of the robot cleaner 100 as illustrated in FIG. 10B, the controller 170 may control the driving unit 150 not to rotate the first rotary member 110 or rotate in a counterclockwise/clockwise direction at a low speed and rotate the second rotary member 120 in a counterclockwise direction at a high speed. Here, the robot cleaner 100 may generate movement power for traveling right-forwards by itself

Such movement power of the robot cleaner 100 for traveling right-forwards may be used as a force for assisting user's manual cleaning, and accordingly, the user may apply a less right pushing force to the push stick 500 to move the robot cleaner 100 right-forwards to perform cleaning.

Meanwhile, a default rotation speed of the first and second rotary members 110 and 120 in the manual cleaning mode may be lower than a default rotation speed of the first and second rotary members 110 and 120 in an automatic cleaning module. That is, if a rotation speed of the first and second rotary members 110 and 120 of the robot cleaner 100 in the manual cleaning mode is high, movement power generated by the robot cleaner 100 may be increased, and thus, the robot cleaner 100 may provide movement power for moving in a direction different to a manual cleaning direction desired by the user. In order to prevent this, the controller 170 may control a rotation speed of the rotary members 110 and 120 as described above. However, this is merely an exemplary embodiment, and various exemplary embodiments of the present invention are not limited thereto.

Meanwhile, when the manual cleaning mode is set, the controller 170 of the robot cleaner 100 according to an exemplary embodiment of the present invention may perform controlling such that traveling of the robot cleaner 100 using a sensing signal received from the external impact sensing unit 131 is not controlled.

In detail, the robot cleaner 100 in the automatic cleaning mode may travel, while avoiding an obstacle using a signal sensed by the external impact sensing unit 131. In more detail, the robot cleaner 100 may determine whether it collides with an obstacle on the basis of a sensing signal from the external impact sensing unit 131, and when the robot cleaner 100 is determined that it collides with an obstacle, the driving unit 150 may be controlled to avoid the obstacle.

However, if traveling of the robot cleaner 100 in the manual cleaning mode is controlled using a sensing signal from the external impact sensing unit 131, there is a possibility of providing movement power in a direction not identical to a user's manual cleaning direction. Thus, the controller 170 may perform controlling such that traveling of the robot cleaner 100 using a sensing signal received from the external impact sensing unit 131 is not controlled in the manual cleaning mode.

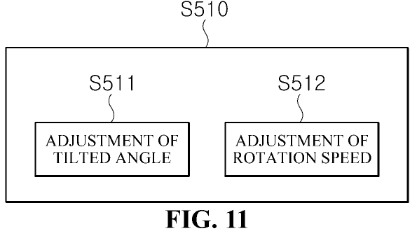

Meanwhile, referring to FIG. 11, the push stick 500 may include an input unit 510 for receiving a user input to set at least one of a tilted angle 511 of the first and second rotary members 110 and 120 and a rotation speed 512 of the first and second rotary members 110 and 120.

Here, the tilted angle 511 may refer to an angle at which at least one of the first and second rotational axes 310 and 320 are tilted with respect to the central axis 300 corresponding to a longitudinal axis of the robot cleaner 100. If a user input for adjusting the tilted angle 511 of the first and second rotary members 110 and 120 is received through the input unit 510 of the push stick 500, the controller 170 may adjust an angle at which a rotational axis of at least one of the first and second rotational axes 310 and 320 with respect to the central axis 300 of the robot cleaner on the basis of the user input.

Also, the rotation speed 512 may refer to a rotation speed of the first and second rotary members 110 and 120. If a user input for adjusting the rotation speed 512 of the first and second rotary members 110 and 120 is received through the input unit 510 of the push stick 500, the controller 170 may adjust a rotation speed of the first and second rotary members 110 and 120 on the basis of the user input.

Meanwhile, according to the exemplary embodiment described above, a case in which a force applied to the push stick 500 is a pushing force or a pulling force has been described as an example, but the present invention is not limited thereto and may be implemented in a manner different from that described above according to another exemplary embodiment of the present invention.

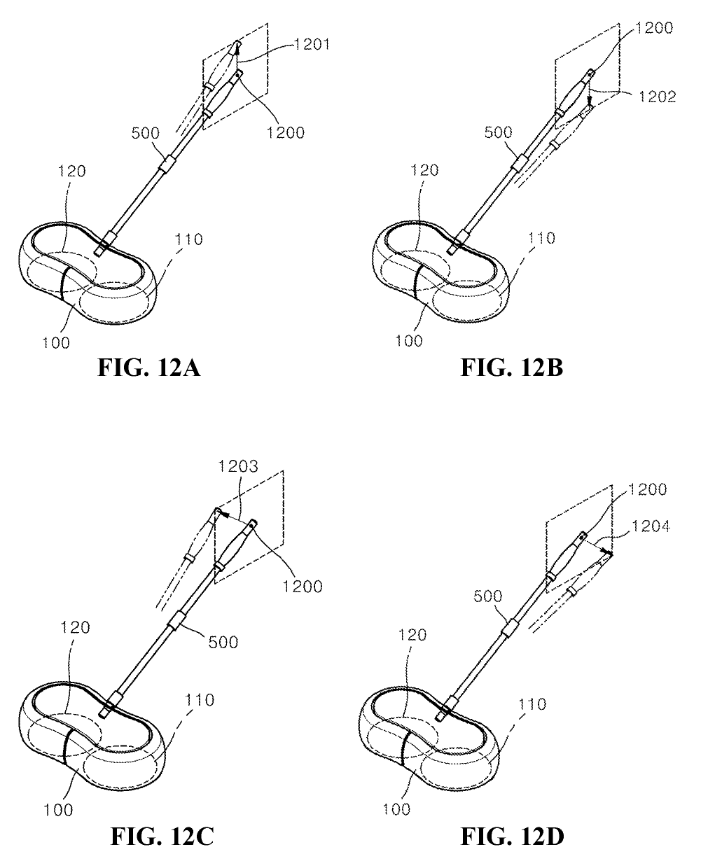

FIGS. 12A to 12D are views illustrating a user's force applied to a push stick according to another exemplary embodiment of the present invention. Referring to FIGS. 12A to 12D, the user may apply a force to the push stick 500 to move the push stick 500 in a specific direction with respect to a reference position 1200. Here, the push stick sensing unit 133 may sense a user's force applied to the push stick 500 and transmit a sensing signal to the controller 170, and the controller 170 may determine a manual cleaning direction of the user using the sensing signal received from the push stick sensing unit 133.

For example, when a user's force for moving the push stick 500 in an upward direction 1201 with respect to the reference position 1200 is sensed by the push stick sensing unit 133 as illustrated in FIG. 12A, the controller 170 may determine a manual cleaning direction of the user as a forward direction of the robot cleaner 100.

In another example, when a user's force for moving the push stick 500 in a downward direction 1202 with respect to the reference position 1200 is sensed by the push stick sensing unit 133 as illustrated in FIG. 12B, the controller 170 may determine a manual cleaning direction of the user as a backward direction of the robot cleaner 100.

In another example, when a user's force for moving the push stick 500 in a left-upward direction 1203 with respect to the reference position 1200 is sensed by the push stick sensing unit 133 as illustrated in FIG. 12C, the controller 170 may determine a manual cleaning direction of the user as a left-forward direction of the robot cleaner 100.

In another example, when a user's force for moving the push stick 500 in a right-downward direction 1204 with respect to the reference position 1200 is sensed by the push stick sensing unit 133 as illustrated in FIG. 12D, the controller 170 may determine a manual cleaning direction of the user as a right-backward direction of the robot cleaner 100.

Here, the controller 170 of the robot cleaner 100 may generate movement power for moving the robot cleaner in a user's manual cleaning direction by controlling rotation of the first and second rotary members 110 and 120, and such movement power of the robot cleaner 100 may be used as a force for assisting the user's manual cleaning. Accordingly, the user may perform cleaning by moving the robot cleaner 100 in a manual cleaning direction by applying a less pushing or pulling force.

Also, the present invention may be implemented in a manner different from those of the cases of FIGS. 12A to 12D described above. For example, the input unit 510 of the push stick 500 may include a button for inputting a manual cleaning direction of the user. In detail, the input unit may include a button for forward cleaning, a button for backward cleaning, a button for leftward cleaning, and a button for rightward cleaning. Also, when the user presses at least one of the plurality of buttons, the controller 170 may generate movement power for moving the robot cleaner 100 in a user's manual cleaning direction by controlling rotation of the first and second rotary members 110 and 120, and such movement power of the robot cleaner 100 may be used as a force for assisting user's manual cleaning.

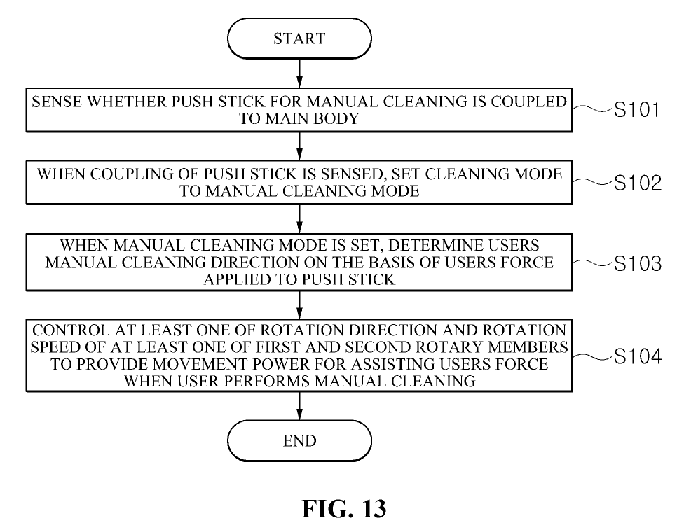

FIG. 13 is a flow chart illustrating a method for controlling a robot cleaner according to various exemplary embodiments of the present invention. Referring to FIG. 13, the robot cleaner 100 may sense whether the push stick for manual cleaning is coupled to the main body 10 (S101). In detail, the opening 30 allowing for attachment or detachment of the push stick 500 may be provided in an upper portion of the main body 10 of the robot cleaner 100, and in the sensing step S101, whether attachment or detachment of the push stick 500 to or from the opening 30 may be sensed and, when the push stick 500 is attached, a user's force applied to the push stick 500 is sensed and a sensing signal may be transmitted to the controller 170.

Also, when attachment of the push stick 500 is sensed, the robot cleaner 100 may be set a cleaning mode to a manual cleaning mode (S102).

When the manual cleaning mode is set, the robot cleaner 100 may determine a user's manual cleaning direction on the basis of a user's force applied to the push stick 500 (S103).

Also, the robot cleaner 100 may control at least one of a rotation direction and a rotation speed of at least one of the first and second rotary members to provide movement power for assisting user's force when manual cleaning is performed in the user's manual cleaning direction (S104).

In detail, in the controlling step S104, at least one of a rotation direction and a rotation speed of at least one of the first and second rotary members 110 and 120 may be controlled such that the robot cleaner travels in a direction corresponding to the user's manual cleaning direction.

In more detail, when the user's cleaning direction is a forward direction, the driving unit 150 may be controlled to rotate the first rotary member 110 in a first direction and rotate the second rotary member 120 in a second direction opposite to the first direction at the same speed as that of the first rotary member 110.

Also, when the user's cleaning direction is a backward direction, the driving unit 150 may be controlled to rotate the first rotary member 110 in the second direction and rotate the second rotary member 120 in the first direction at the same speed as that of the first rotary member 110.

Also, when the user's cleaning direction is a lateral direction, the driving unit 150 may be controlled such that one of the first and second rotary members 110 and 120 is different to that of the other.

The method for controlling the robot cleaner 100 according to an exemplary embodiment of the present invention may further include sensing an external impact applied to the bumper provided on an outer side of the main body 10; and when a manual cleaning mode is set, performing controlling such that traveling of the robot cleaner 100 using a sensing signal corresponding to an external impact is not controlled.

Also, the method for controlling the robot cleaner 100 according to an exemplary embodiment of the present invention may further include: when a user input for setting at least one of a tilted angle of the first and second rotary members 110 and 120 and a rotation speed of the first and second rotation members 110 and 120 is received in the push stick 500, controlling at least one of the tilted angle of the first and second rotary members 110 and 120 of the robot cleaner 100 and a rotation speed of the first and second rotary members 110 and 120.

Meanwhile, the control method according to various exemplary embodiments of the present invention described above may be implemented by a program code and provided to each server or device, in a state of being stored in various non-transitory computer readable mediums.

The non-transitory computer readable medium is a medium that semi-permanently stores data therein and is readable by a device, rather than storing data for a short time such as a register, a cache, a memory, and the like. In detail, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

Although the exemplary embodiments have been illustrated and described hereinabove, the present disclosure is not limited to the above-mentioned specific exemplary embodiments, but may be variously modified by those skilled in the art without departing from the scope and spirit of the present disclosure as disclosed in the accompanying claims. These modifications should also be understood to fall within the scope of the present disclosure.

1. A robot cleaner comprising:
a main body;
a driving unit provided in the main body and supplying power for traveling of the robot cleaner;
first and second rotary members respectively rotating about first and second rotational axes based on power from the driving unit to provide movement power for traveling of the robot cleaner and allowing cleaners for wet cleaning to be fixed thereto;
a push stick sensing unit sensing whether a push stick for manual cleaning is coupled to the main body of the robot cleaner; and
a controller setting a manual cleaning mode, among cleaning modes of the robot cleaner, when coupling of the push stick is sensed.

2. The robot cleaner of claim 1, wherein when the manual cleaning mode is set, the controller determines a cleaning direction of a user on the basis of a user's force applied to the push stick and control at least one of a rotation direction and a rotation speed of at least one of the first and second rotary members to provide movement power for assisting the user's force.

3. The robot cleaner of claim 2, wherein the controller controls at least one of the rotation direction and a rotation speed of at least one of the first and second rotary members such that the robot cleaner travels in a direction corresponding to the determined cleaning direction.

4. The robot cleaner of claim 3, wherein
an opening allowing the push stick to be attached to or detached from is provided in an upper portion of the main body, and
the push stick sensing unit senses attachment or detachment of the push stick to or from the opening, and when the push stick is attached, the push stick sensing unit senses a user's force applied to the push stick and transmit a sensing signal to the controller.

5. The robot cleaner of claim 4, wherein
when the user's cleaning direction is a forward direction, the controller controls the driving unit to rotate the first rotary member in a first direction and rotate the second rotary member in a second direction opposite to the first direction at the same speed as that of the first rotary member, and
when the user's cleaning direction is a backward direction, the controller controls the driving unit to rotate the first rotary member in the second direction and rotate the second rotary member in the first direction at the same speed as that of the first rotary member.

6. The robot cleaner of claim 4, wherein when the user's cleaning direction is a lateral direction, the controller controls the driving unit such that a rotation speed of one of the first and second rotary members is different from that of the other.

7. The robot cleaner of claim 1, further comprising:
a bumper provided on an outer circumference of the main body to protect the main body; and
an external impact sensing unit sensing an external impact applied to the bumper,
wherein
when the manual cleaning mode is set, the controller performs controlling such that traveling of the robot cleaner using a sensing signal received from the external impact sensing unit is not controlled.

8. The robot cleaner of claim 1, wherein a default rotation speed of the first and second rotary members in the manual cleaning mode is lower than that of the first and second rotary members in an automatic cleaning mode.

9. The robot cleaner of claim 1, wherein the push stick includes an input unit receiving a user input to set at least one of a tilted angle and a rotation speed of the first and second rotary members.

10. A method for controlling a robot cleaner which travels in a specific movement direction by rotating at least one of first and second rotary members respectively rotating about first and second rotational axes, the method comprising:
sensing whether a push stick for manual cleaning is coupled to a main body of the robot cleaner;
when coupling of the push stick is sensed, setting a cleaning mode of the robot cleaner to a manual cleaning mode;
when the manual cleaning mode is set, determining a user's cleaning direction; and
controlling at least one of a rotation direction and a rotation speed of at least one of the first and second rotary members to provide movement power in the determined cleaning direction.

11. The method of claim 10, wherein,
in the determining, when the manual cleaning mode is set, a user's cleaning direction is determined on the basis of a user's force applied to the push stick, and
in the controlling, at least one of a rotation direction and a rotation speed of at least one of the first and second rotary members is controlled to provide movement power for assisting the user's force when manual cleaning is performed in the determined cleaning direction.

12. The method of claim 11, wherein,
in the controlling, at least one of a rotation direction and a rotation speed of at least one of the first and second rotary members is controlled such that the robot cleaner travels in a direction corresponding to the determined cleaning direction.

13. The method of claim 12, wherein
an opening allowing the push stick to be attached to or detached from is provided in an upper portion of the main body, and
in the sensing, attachment or detachment of the push stick to or from the opening is sensed, and when the push stick is attached, a user's force applied to the push stick is sensed and a sensing signal may be transmitted to a controller.

14. The method of claim 13, wherein,
in the controlling,
when the user's cleaning direction is a forward direction, a driving unit is controlled to rotate the first rotary member in a first direction and rotate the second rotary member in a second direction opposite to the first direction at the same speed as that of the first rotary member, and
when the user's cleaning direction is a backward direction, the driving unit is controlled to rotate the first rotary member in the second direction and rotate the second rotary member in the first direction at the same speed as that of the first rotary member.

15. The method of claim 13, wherein,
in the controlling, when the user's cleaning direction is a lateral direction, the driving unit is controlled such that a rotation speed of one of the first and second rotary members is different from that of the other.

16. The method of claim 10, further comprising:
sensing an external impact applied to a bumper provided on an outer side of a main body of the robot cleaner; and
when the manual cleaning mode is set, performing controlling such that traveling of the robot cleaner using a sensing signal corresponding to the external impact is not controlled.

17. The method of claim 10, wherein a default rotation speed of the first and second rotary members in the manual cleaning mode is lower than that of the first and second rotary members in an automatic cleaning mode.

18. The method of claim 10, further comprising:
receiving a user input to set at least one of a tilted angle and a rotation speed of the first and second rotary members in the push stick.
